(19) United States
(12) Patent Application Publication
(10) Pub. No.: US 2026/0249517 A1
(43) Pub. Date: Aug. 27, 2026

(54) PROCESS AND APPARATUS FOR INCREASING INTRINSIC VISCOSITY OF POLYCONDENSATES

(71) Applicant: EREMA Engineering Recycling Maschinen und Anlagen Gesellschaft m.b.H., Ansfelden (AT)

(72) Inventors: Feichtinger Klaus, Linz (AT); Hermann Wolfgang, Linz (AT)

(73) Assignee: EREMA Engineering Recycling Maschinen und Anlagen Gesellschaft m.b.H., Ansfelden (AT)

(21) Appl. No.: 18/857,757

(22) PCT Filed: Apr. 20, 2023
(86) PCT No.: PCT/AT2023/060133

§ 371 Date: Oct. 17, 2024

(30) Foreign Application Priority Data
Apr. 20, 2022 (AT) A50260/2022

(51) Int. Cl. B29B 7/42; B29B 7/82; B29B 17/02; C08J 11/04

(52) U.S. Cl. CPC B29B 7/42; B29B 7/823; B29B 17/02; C08J 11/04; B29B 2017/0224; C08J 2367/02

(57) ABSTRACT

Process and apparatus for processing of polycondensates, in particular for recycling processing of contaminated polycondensates, comprising the following processing steps: a) initially charging the polycondensates/materials to be processed, in particular in a container, b) at least partially, especially completely, melting the polycondensates, in particular by extruding in an extruder, and preparing a polymer melt, c) mixing the polymer melt, d) cooling the polymer melt, e) treating the mixed and cooled polymer melt in a melt reactor, in particular for polycondensation/postcondensation, to increase the intrinsic viscosity and/or to purify the polymer melt.

The present invention relates to a process and an apparatus for processing polycondensates or materials containing polycondensates, in particular for recycling processing of contaminated polycondensates, according to claim 1 and claim 12, respectively.

Essentially, it concerns a process sequence or a sequence of apparatuses that can be used in the processing of recycling materials consisting of or containing thermoplastic polycondensates. Polycondensates are the products of polycondensation, wherein monomers with at least two reactive functional groups are linked to form a polymer by splitting off low-molecular compounds. Alongside chain polymerization and polyaddition, polycondensation is one of the most important polymerization reactions.

The polycondensates that frequently occur during recycling processing include PET, PET-G, PET-A and their co-polymers, PA, PC, polycondensates from renewable raw materials such as PLA, but also other ester compounds that polymerize or polycondense under temperature and vacuum.

In recycling processing, the polycondensates, which are solid in the use state, are first converted into a polymer melt, in particular with an extrusion system, e.g. with a known PCU (preconditioning unit)/cutter-compressor-extruder system, wherein the PCU can be placed under vacuum or inert gases. The melt can be filtered and is then transferred via a melt cooler to a melter reactor-MSP (melt state process) reactor or an LSP (liquid state process) reactor—where a reaction, in particular a (post-) polycondensation, and/or purification of the polymers takes place. Subsequently, the melt treated in this way is fed to a downstream apparatus that either produces granulates or semi-finished products in line, such as fibers, filaments, tapes, pre-forms for the production of bottles or containers or films with corresponding downstream products.

Such processes and apparatuses, which are basically suitable for recycling polycondensates, are known from prior art.

Polycondensates, such as polyethylene terephthalates, are sensitive and are subject to various degradation processes, e.g. hydrolytic degradation, thermal degradation or thermo-oxidative degradation. Thermal degradation is primarily a problem in processes in the melting phase and leads, for example, to a decrease in the intrinsic viscosity iV, the formation of carboxyl end groups or acetaldehyde or to yellowing of the polymer, etc. Oxygen further accelerates and intensifies these degradation reactions with the formation of free radicals.

High melt temperatures often lead to a negative impact on the quality of the final polymers and cause, among other things, a shortening of the molecular chains, undesirable gel formation or even burning of particles and polymer in the melt. The decomposition of the polymer or of ingredients is also promoted by high temperatures. As a result, some of the efforts of the upstream processes to increase material quality, e.g. pre-treatment, filtration, degassing, are reversed or counteracted.

In this context, the property of polycondensates is exploited that damage caused during the manufacture and/or use of the products—for example the shortening of the polymer chains due to thermal and/or hydrolytic degradation, or the penetration of foreign substances into the polymer—can be “repaired” relatively easily, for example by re-polymerization. This means that the same or almost the same properties as the original product can be produced again. Some properties can even be improved by such a treatment, for example the mechanical properties, but also the reduction of foreign substances that have previously migrated into the polymer during use, for example.

Influencing the properties of used polycondensate products is widely known and can be done by polycondensation reactions or purification by diffusion, before melting, during melting or after the melting process in the liquid phase or in the solid phase. Solid state post-condensation reactors (solid state SSP reactors) or melter reactors (MSP or LSP reactors) are generally used for this purpose.

Solid-phase post-condensation (SSP) is a process for the further condensation of polycondensates in order to increase their molecular weight under the gentlest possible conditions. The granulated polycondensate is post-processed under inert gas or vacuum. Compared to melt polycondensation, this process has the advantage of a lower reaction temperature and therefore less discoloration of the polycondensates. It also avoids viscosity problems, which can be serious in a polycondensate melt. However, an SSP treatment regularly requires more time, e.g. 10-20 h compared to around 1 h for an MSP or LSP treatment. The systems are therefore larger and less flexible. Variable viscosities (IV) at the input are more difficult to regulate.

Melt polycondensation under vacuum also utilizes the inherent properties of polycondensates, in particular PET to (re) condense in the melt phase, which leads to an increase in the IV value and the efficient removal of volatile impurities. Compared to the SSP, the reaction rate in the melt is significantly higher than in the solid phase.

In the case of the treatment of materials from the field of processing industrial or post-consumer waste by means of a melt and a melt reaction treatment, the following problem often arises due to the different properties of the input materials, in particular due to the differences in viscosity, contamination, ingredients, etc.:

When the material is transferred into the melt, e.g. by an extrusion system, it is often not possible or not enough attention is paid to achieving a narrow temperature distribution of the melt. This is partly due to the melting process and partly due to the mechanical filtration of the melt, wherein different melt temperatures are generated depending on the polymer properties and degree of contamination. In some cases, low-viscosity parts of the melt remain colder and high-viscosity parts of the melt receive more energy in the form of shear, for example in the extruder screw or during filtration, and therefore heat up more. These differences in viscosity are very often already present in the input material and are sometimes not known or recognizable or are not taken into account. However, this leads to problems in the preparation process and to a reduced quality of the end products.

It is thus the task of the present invention to provide a process and an apparatus for the advantageous processing of polycondensates or of materials containing polycondensates, with which increased process reliability and increased quality of the end products can be achieved. In particular, this should also increase the intrinsic viscosity of the material or reduce the content of impurities or contaminants.

According to the invention, this task is solved by a process for processing polycondensates or materials containing polycondensates, in particular for recycling processing contaminated polycondensates, e.g. PET, PA, PC or PLA, wherein the process comprises the following processing steps:
a) Presentation of the polycondensates or materials to be processed, in particular in a container,
b) at least partial, in particular complete, melting of the polycondensates, in particular by extrusion in an extruder, and production of a polymer melt,
c) Mixing the polymer melt,
d) Tempering, in particular cooling, of the polymer melt,
e) Treatment of the mixed and tempered, in particular cooled, polymer melt in a melter reactor, in particular for polycondensation or post-condensation, for increasing the intrinsic viscosity and/or for purifying the polymer melt.

Similarly, the objective problem is solved in accordance with the invention by an apparatus for processing polycondensates or materials containing polycondensates, in particular for recycling processing contaminated polycondensates, wherein the apparatus comprises:
a melting apparatus for melting the polycondensates to be processed and for producing a polymer melt,
a mixing apparatus downstream of the melting apparatus for mixing the polymer melt,
a tempering apparatus, in particular a cooling apparatus, downstream of the melting apparatus for tempering, in particular reducing, the temperature of the polymer melt,
a melter reactor connected thereto for treating the mixed and tempered, in particular cooled, polymer melt, in particular for polycondensation or post-condensation, for increasing the intrinsic viscosity and/or for purifying the polymer melt.

When recycling different or inhomogeneous materials, different material flows come together, e.g. from the packaging of containers and bottles, which have a high initial viscosity, with materials from the thermoforming sheet sector, which have a lower viscosity in the melt and/or with fibrous materials, which have a very low viscosity. This results in an average core temperature of 275° C. for some PET blends, with a considerable range of +/−20° C.

When a polycondensate melt is treated in a melter reactor, for example an MSP reactor, a reaction and/or purification is carried out under temperature, residence time and with the removal of moisture, oxygen, glycol or other substances, among other things.

If such polymerization or post-condensation is carried out in the melter reactor, the narrower the temperature spectrum of the input melt and the narrower the residence time spectrum in the melter reactor, the narrower the molecular chain distribution.

The residence time spectrum in the melter reactor is kept as narrow as possible by means of suitable measures, such as conveying equipment, level measurements, etc. Furthermore, the application of a vacuum and/or purging with inert gases ensures that the reaction proceeds largely uniformly along the reactor.

Taking into account that the reaction rate of a chemical reaction roughly doubles with a temperature increase of 10° C., it is advantageous if the melt has a narrow temperature distribution when it enters the melter reactor.

It has also proved advantageous to keep the absolute temperature of the melt as low as reasonably possible when it enters the melter reactor. Although this reduces the reaction speed and extends the time required in the reaction system, it leads to greater process reliability and better end quality. The influence of temperature on the reaction rates is subject to an exponential relationship, whereas the change over the residence time only follows a linear relationship. By setting a lower melt temperature, the viscosity range or molecular chain distribution can also be kept narrower, as short-chain polymer parts, i.e. polymer parts with lower viscosity, polymerize faster than long-chain molecules at a certain temperature.

It should also be noted that, in addition to the desired polycondensation reactions, there are various undesirable side reactions during the reaction in the melter reactor that negatively affect the quality of the final polymer. These side reactions are also considerably lower at lower temperatures. The residence time has an increasing influence on these side reactions, but the temperature has an exponential influence, i.e. the number of undesired side reactions increases disproportionately at higher temperatures.

Acetaldehyde is a particularly undesirable interfering substance in this context. Acetaldehyde provides a fruity apple flavor, especially in beverage bottles, which is extremely undesirable when packaging water. However, such by-products can also have a negative impact on processability.

High demands are also regularly placed on the melt viscosity range of the end products. A range of +/−0.002 dl/g is a common value for new goods. Due to the high use of recyclates, this range can also be maintained during reprocessing.

The varying content of residual catalysts, fillers, etc. influences the reaction rate and to some extent also the diffusion rate. For these reasons too, it is advantageous to set the lowest sensible reaction temperature and temperature range.

Another situation that typically occurs during recycling is that residues of migration substances, contaminants, etc. remain in the polymer. These impurities regularly lead to a loss of quality in the material produced. For example, a material becomes significantly more discolored at higher temperatures than when the time is extended.

Accordingly, several factors must be taken into account, in particular
that an increase in the temperature of the melt is often disadvantageous and undesirable for the subsequent process,
that inconsistent and excessively high melt temperatures often lead to quality problems, and/or
that a homogenized, mixed and tempered, in particular cooled, melt is often advantageous for improved product quality and thus a constant discharge volume and a homogeneous viscosity distribution can be achieved.

According to the invention, there is a special combination of extruder, melt mixer and melt temperer, in particular melt cooler and melter reactor. The prerequisites and preparation of the melt for a process in an MSP/LSP melter reactor are particularly delicate and demanding-appropriate preparation and adjustment of the melt parameters is therefore more important and more difficult than for an SSP, for example.

For this reason, it is proposed in accordance with the invention that, when processing polycondensates, in particular from secondary raw material sources, by means of a melter reactor, the temperature of the melt is equalized, tempered, in particular lowered, and reduced in width upstream of the melter reactor. Particular attention must be paid to this, especially with the high temperatures regularly present in the melter reactor. All this is ensured by the process and the apparatus according to the invention.

The uniformity of the temperature is to be understood both temporally and locally, i.e. the temperature should be as constant as possible over a longer period of time, i.e. from several minutes to hours, and the local or local deviation transverse to the flow direction should also be as small as possible.

In every duct system, there is a certain temperature distribution or radial temperature gradient from the inside to the outside at right angles to the direction of flow. At higher flow rates, corresponding channel cross-sections are required and this results in a local temperature inhomogeneity transverse to the flow direction. Local cross-mixing of the melt is therefore advantageous.

However, during the course of the continuous process, in particular the extrusion process, there are also temperature changes over time, e.g. cleaning the filters results in higher shear in the extruder for a short time, which temporarily leads to higher temperatures. Different material shapes, e.g. regrind, partially crystallized fibers, thick fibers, highly stretched fibers, but also iV differences in the starting material, cause the material to be sheared differently in the extruder, which also leads to further temperature inhomogeneities over time and the resulting viscosity fluctuations during the process.

Temperature equalization: targeted temperature control reduces the time component of the temperature deviation.

Temperature-width reduction: the melt temperature has a distribution across the channel and a distribution over time that is determined by the previous influences and/or the material components. Mixing reduces this temperature range, as does tempering.

The term “tempering” is used here to mean adjusting the temperature of the melt to the desired or advantageous temperature. This can be a reduction, but also an increase in temperature. The temperature control apparatus or the melt/temperature control mixer is suitable, designed, controlled and/or intended for cooling and/or heating.

Advantageously, tempering involves a reduction in temperature or cooling. This advantageously takes place in an appropriate cooling apparatus or in a melt/cool mixer.

However, there are also situations in which it is advantageous or necessary to increase the temperature, usually only by a few degrees. This is the case, for example, if the temperature upstream of the cooler is too low and the melt has to be heated, e.g. if the melt is too cold from the upstream extrusion process because it is very thin and therefore requires less energy input in the extruder. Accordingly, tempering involves an increase in temperature or heating. This advantageously takes place in an appropriately suitable and designed temperature control apparatus or the melt/temperature control mixer.

In the process according to the invention, the processing steps are advantageously carried out in the specified sequence a) to e).

However, it is particularly advantageous if steps c) and d) are carried out simultaneously or in a joint process step, i.e. if the polymer melt is mixed and tempered, in particular cooled, at the same time.

To improve purification, it is advantageous if the polymer melt is filtered before steps c) and d) to remove any components and/or impurities that have not melted.

The product quality is also improved by degassing the filtered polymer melt before steps c) and d).

A particularly efficient and advantageous mixture and a narrow residence time spectrum, which is fundamentally advantageous, is achieved if the polymer melt is mixed distributivity.

It is advantageous for the product quality if the polymer melt is mixed and/or tempered, in particular cooled, in such a way that the temperature distribution in the polymer melt, in particular in the phase from before mixing or tempering, in particular cooling, to immediately before the melter reactor, preferably in the phase from the start of melting during extrusion to before the melter reactor, in particular over the entire course of the process, is <+/−10° C., in particular <+/−5° C., preferably <+/−1° C. This also allows a narrow viscosity range or molecular chain distribution to be achieved.

In order to achieve a high product quality and higher process reliability and to avoid side reactions, it is also advantageous if the polymer melt is tempered, in particular cooled, in such a way that the temperature of the polymer melt immediately before or on entering the melter reactor is 5-25% lower than the temperature of the polymer melt immediately before mixing and tempering, in particular cooling, or before steps c) and d).

In this context, it is also advantageous and the advantages just mentioned can be achieved if the polymer melt is tempered, in particular cooled, in such a way that the temperature of the polymer melt immediately before or when it enters the melter reactor is only relatively slightly, i.e. by 1-10%, above the melting range of the polymer.

An advantageous process control already provides for special steps at the beginning of the preparation process, namely that the polycondensates or materials are comminuted and/or heated before melting according to step b), in particular during step a), wherein it is preferably provided that the polycondensates or materials are heated and permanently mixed while maintaining their lumpiness and pourability, and optionally degassed, softened, dried, increased in viscosity and/or crystallized.

A further advantageous and efficient process is that at least the processing steps c), d) and e), in particular all the intended processing steps, follow one another directly and immediately in terms of time and location, in each case without any further intervening processing step.

In the apparatus according to the invention, it can advantageously be provided that the melter reactor is connected directly and directly in the conveying direction to the mixing apparatus or the temperature control apparatus, in particular the cooling apparatus, without any further interposed functional unit, or is connected downstream of the mixing apparatus or the temperature control apparatus, in particular the cooling apparatus, and is coupled in series in terms of process.

An effective and advantageous apparatus provides that the melting apparatus is an extruder, wherein the extruder comprises in particular a melt filter and/or a degassing zone.

An overall arrangement which is advantageous for achieving high-quality end products is characterized in that a cutter/compactor is connected upstream of the melting apparatus, wherein in particular a cutter/compactor/extruder combination is provided for comminuting and/or heating the polycondensates or materials. The cutter/compactor is preferably set up and suitable for heating and permanently mixing the polycondensates or materials supplied while maintaining their lumpiness and pourability, and, if necessary, degassing, softening, drying, increasing their viscosity and/or crystallizing them.

An efficient and advantageous apparatus is that the mixing apparatus is a distributive mixer.

In this context, it is particularly advantageous if the mixing apparatus is also the temperature control apparatus, in particular the cooling apparatus, wherein in particular a melt temperature control mixer or melt temperature control/mixer, preferably a melt cooling mixer or melt cooler/mixer, is provided.

An MSP reactor or an LSP reactor is preferably used as the melter reactor.

The exact design of the melter reactor is relatively unimportant for the application according to the invention. It can advantageously be a melter reactor according to the design of DE 1745541, but also according to the design of DE 4013912 or DE 4126425.

What all melter reactors have in common is that an attempt is made to greatly increase the surface area of the melt under reduced pressure conditions or in an inert gas flow and to start a polycondensation reaction in order to extend the polymer chains and thus optimize the mechanical properties of the polymer when it is reused in an end product. Furthermore, the diffusion process enables the removal of undesirable substances that may have entered the polymer through previous use. This makes it possible to use these polymers again in applications where food suitability, odor and skin compatibility must be ensured. The reaction products or diffusion products are removed either by the negative pressure or by the inert gas flow.

In order to achieve good product quality, it is advantageous if the mixing apparatus and/or the temperature control apparatus, in particular the cooling apparatus, or the melt temperature control mixer, preferably the melt cooling mixer, can be controlled or are controlled in such a way that the temperature distribution in the polymer melt is <+/−10° C., in particular <+/−5° C., preferably <+/−1° C. In this context, it is particularly advantageous if this temperature distribution is achieved in the area upstream of the mixer or temperature control unit, in particular the cooler, up to directly upstream of the melter reactor, preferably in the area of the melting unit or the extruder up to upstream of the melter reactor, in particular in the entire system or apparatus.

In order to achieve and adjust a good product quality and a higher process reliability, it is advantageously provided if the mixing apparatus and/or the temperature control apparatus, in particular cooling apparatus, can be controlled or are controlled in such a way that the temperature of the polymer melt immediately before or upon entry into the melter reactor is 5-25% lower than the temperature of the polymer melt immediately before the mixing apparatus and the temperature control apparatus, in particular cooling apparatus, or before the temperature control mixer, preferably cooling mixer. In this way, side reactions can be reduced and a narrow iV width can be obtained in the end product.

In order to also achieve these advantages, it may advantageously be provided that the mixing apparatus and/or the temperature control apparatus, in particular the cooling apparatus, are controllable or controlled in such a way that the temperature of the polymer melt immediately before/as it enters the melter reactor is 1-10% above the melting range of the polymer.

From a system engineering point of view, it can be advantageous to use feed pumps for the melt both upstream of the temperature control unit, in particular the cooler or mixer, and downstream of the temperature control unit, in particular the cooler or mixer, and/or downstream of the melter reactor, in order to overcome any pressure differences. However, care must be taken to ensure that this does not lead to a significant increase in temperature, in particular due to any pump downstream of the temperature control unit, especially the cooler/mixer, upstream of the melter reactor.

The core temperature of the melt is advantageously selected according to the desired residence time and the desired reaction rate in the melter reactor or reaction vessel. It has been shown that you should generally try to set the lowest possible core temperature.

The temperature control medium, in particular the cooling medium, of the melt temperature control system, in particular the melt cooling system, e.g. the melt cooler/mixer, is controlled according to the core temperature of the melt. For this purpose, the temperature can be recorded both before and after the melt temperature control system, in particular the melt cooling system. In advantageous temperature control systems, especially cooling systems, the temperature of the melt can also be measured in the temperature control section, especially the cooling section. This temperature is used to set the temperature control medium, in particular the cooling medium.

It is advantageous if the melt temperature is sufficiently representative. The melt temperature in a supply pipe at the wall or in the middle of the pipe differs considerably in some cases. It is therefore advisable and sensible to measure the temperature both at the wall and in the middle of the pipe. The thicker the pipe, the more sensible it is to measure at several points across the cross-section.

Advantageous embodiments of the process according to the invention and of the apparatus according to the invention are illustrated and explained below by means of more general and more specific embodiment examples, which are not to be understood restrictively:

The recycling of PET materials from very different sources is often required, for example from filament remnants, fiber remnants, thermoforming sheets (e.g. cheese or sausage packaging, tool or electronics packaging), PET bottle material (e.g. water bottles or soft drinks) etc. The viscosity range is regularly considerable and is around 0.5 dl/g (for fibers) to 0.79 dl/g (for bottle grinds).

Such an inhomogeneous input material mix results in a correspondingly broad molecular chain distribution and a wide viscosity range. Furthermore, such mixtures are rarely characterized by exactly the same components, i.e. the quantitative proportions of the different materials are different and are also constantly changing.

In the melting process, the particles, usually smaller particles in the form of polymer flakes, fibers or films, experience different shear stresses depending on their mechanical properties (size, elongation, thickness, etc.) and their viscous properties. This leads to a broad melt temperature distribution, e.g.: 276° C.+/−20° C. (after the extruder), with the disadvantageous effects described above, which are associated with such a broad and varying temperature distribution. After the filter, the melt temperature distribution is still approx. 277° C.+/−15° C. After the melt cooler/mixer, the melt temperature distribution is 260° C.+/−3° C., wherein a range of less than 3° C. can also be achieved. This means that the temperature of the melt is equalized, lowered and reduced in width before it reaches the melter reactor.

Example PET (A-PET) for packaging and fibers:

### Melting Temperature Ranges PET

Melting temperature of PET: >250° C., typically 256° C.
Melting temperature during recycling as a rule: 275° C. to 310° C. (depending on process, contamination and filtration fineness)
Target temperature range before LSP: 260° C. to 270° C.+/−3° C.
Cooling in the range of: 5 to 25% (at reference temperature 260° C.)

Viscosity lift as a function of melt temperature:

The residence time t in the melter reactor is constant.

The input viscosity before the melter reactor is 0.5 dl/g.

| | | |
|---|---|---|
| Melting temperature: | 270° C. | Viscosity achieved 0.53 dl/g |
| Melting temperature: | 280° C. | Viscosity achieved 0.57 dl/g |
| Melting temperature: | 290° C. | Viscosity achieved 0.62 dl/g |

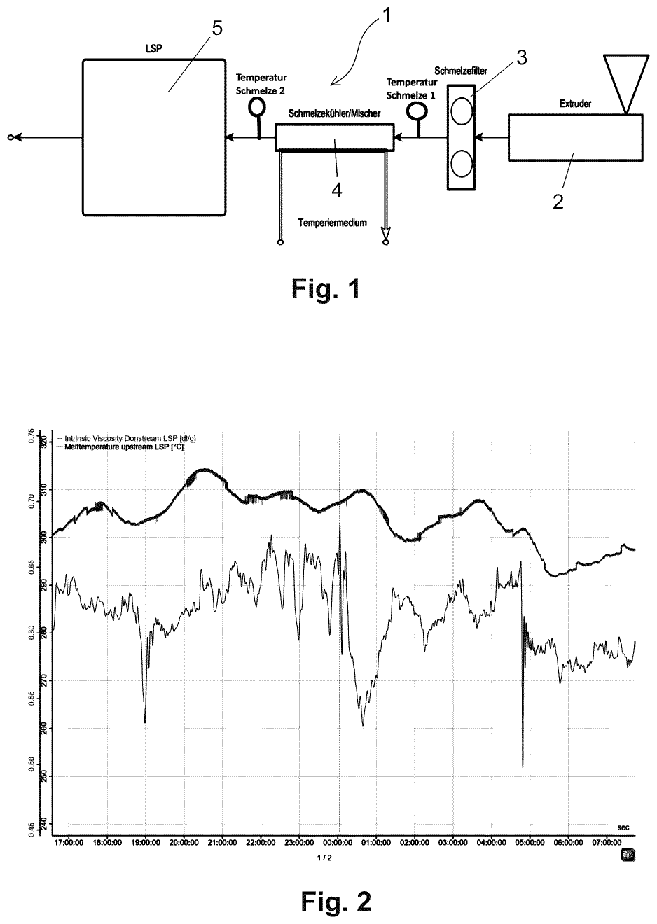

An advantageous diagram of an advantageous apparatus or arrangement or system 1 is shown in FIG. 1 and an exemplary process is also explained with reference to FIG. 1. This is an exemplary schematic diagram to illustrate the most important components and units of this apparatus. Accordingly, this representation also does not claim the final accuracy of all constructive details and proportions.

Not shown in FIG. 1 is an optional container in the form of a classic cutting/compactor or preconditioning unit (PCU). In the present case, this could be arranged to the right or upstream of the extruder. Such a cutter/compactor or container is filled with the recycled polymer material to be processed. The polymer material is placed in the container, crushed using mixing and crushing tools, mixed and heated until it softens, but is not usually melted. The chunkiness of the sticky polymer particles remains intact. In addition, the material undergoes a pretreatment and is, for example, dried, pre-compacted, and, depending on the material, the viscosity is increased.

When processing secondary raw materials from polycondensates, an extrusion process is used to melt the polycondensates, depending on the shape of the materials in question (e.g. fibers, granulates, agglomerates, film shreds, thick-walled regrind, etc.). The secondary raw materials can come from different sources and can be contaminated with solids, but also with liquid substances, such as cotton fibers or spinning auxiliaries, which can consist of oils. Furthermore, these substances very often have different viscosities when melted.

The extruder 2 shown in FIG. 1 can be connected tangentially in the lowest area of this cutter/compactor or container. The material is discharged from the container and transferred to extruder 2, where it is picked up by the screw. The material is melted and plasticized in the foremost section of extruder 2, on the left in FIG. 1, by increasing the pressure.

Single-screw extrusion systems or multi-screw extrusion systems, such as twin screws, can be used in this melting process. The well-known PCU extruder system, which makes it possible to partially evaporate unwanted substances in the PCU, compact the material and heat or soften it, has proved particularly successful. This system also has forced feeding of the extruder, which is particularly advantageous for poorly flowing fiber materials. The extruder then melts the material and optionally degasses the polymers. This process can also be supported by negative pressure or inert gases in the PCU.

The melt is then filtered in a filtration unit 3, which removes both solid and gel-like components from the melt.

Downstream and then to the filtration unit 3, and after this melting process and the first cleaning step, the melt is transferred to the melt cooler/mixer 4, usually via a melt pump (not shown). This has the task of reducing the temperature inhomogeneities that occur both spatially and temporally. At the same time, the average melt temperature is lowered. This is necessary because, among other things, the scattering of the different input materials results in different melt temperatures. Furthermore, the filtration process also leads to temporal or local inhomogeneities.

After the temperature of the melt has been lowered and equalized in the melt cooler/mixer 4, the melt is transferred to the melter reactor 5.

After passing through the reaction or cleaning process in the melter reactor 5, the molten material then enters a discharge unit and can be post-processed, for example granulated, if necessary. However, it can also be formed directly into a finished or semi-finished product, e.g. fibers, films, bottle preforms, etc.

The quantity, temperature and/or speed of the cooling medium is adjusted by measuring the melt temperature before or after the melt cooler/mixer 4 so that the desired target temperature is reached. As can be seen in FIG. 1, at least the melt temperature 1 is recorded here and the temperature control medium is adjusted so that the desired temperature is reached. This can be controlled with the melt temperature 2. The temperature measurement can be carried out at different locations within the pipe, at the outermost edge and/or in the middle of the pipe. For very high system throughputs, it is advantageous to install thicker pipes and/or several pipes. In the case of thick pipes, it is advantageous to measure the temperature at several points within the pipe. The temperature measurement is ideally carried out with several temperature recording devices, wherein the temperature is recorded representatively over the cross-section of the inflow and/or outflow duct

By measuring the temperature distribution within the feed and discharge pipes, both the mixing quality and the cooling rate can be checked. The mixing quality can be recognized by the narrower temperature distribution and the cooling quality by the reduction in the average temperature.

### Comparative Tests:

The following tests were carried out on an exemplary test system according to the invention. This was a PCU/extruder combination INTAREMA 80 TE, equipped with a melt filter SW 4/134 according to the following system configuration:

| | Apparatus type | Comment |
|---|---|---|
| Fiber pre-shredding | Micromat 1500 single- | Lindner |
| | shaft shredder | Screen diameter 70 mm |
| Process unit | Intarema 1108 TE | EREMA |
| | | PCU diameter 1100 mm; extruder |
| | | diameter 80 mm, extrusion degassing |
| Melt piston filter | RTF 4/134 | EREMA, filtration 50 μm |
| Melt pump gear wheel | SP 45 | Maag |
| Melt cooler/mixer | P1 145 DB | Promix optional, depending |
| | | on the test variant |
| Melting reactor | KA 102 | Prototype design similar to DE 1745541 |
| Granulation | Strand pelletizing | Maag |
| | Primo 60 E | |

The materials processed in this way are made up of fiber waste from various areas of a spinning factory. Waste (lumps), undrawn fibers, monofilaments and drawn fibers were used. Furthermore, the fibers had different spinning oil contents in the range of 0.3 to 2 wt %. The initial moisture content also varied, in some cases by 10 wt % and more.

The material was pre-shredded using the single-shaft shredder. Alternatively, mills can also be used.

Using the PCU/extruder combination, the fibers were compacted, dried and heated and, after an appropriate residence time in the PCU, transferred to the single-screw extruder. After melting, the material was degassed and passed through the melt filter device.

The filtered melt was then conveyed to the melt cooler/mixer via the melt pump. The cooler/mixer used in this case was a static mixer without moving elements. The temperature of the cooler/mixer is controlled with thermal oil, which can be both heated and cooled. Both the melt temperature before the cooler/mixer and the temperature afterwards were recorded in order to check the effectiveness of the unit. The viscosity was also measured after the melter reactor. Particular attention was paid to the stability of the viscosity over time.

For comparison, the melt cooler/mixer was removed and the melt was transferred directly into the melter reactor.

The melter reactor was a horizontal disk reactor, similar to the design according to DE 1745541. The polymer mass is passed through the reaction chamber several times in free-falling veils. Rotating disks draw the polymer mass from a sump and the polymer mass flows back as a thin film. This process achieves a very large surface area in relation to the volume of the reaction mass, which enables the evaporation of released reaction products in a short time and promotes a polymer reaction.

In this case, the disk reactor was pressurized with a vacuum of 6 mbar. The disks rotated at a speed of 1 rpm. The average residence time of the material in the reactor was approx. 60 min.

After leaving the reactor, the material was granulated in the strand pelletizer.

The results were as follows:

### Without Melt Cooler/Mixer:

Throughput of approx. 350 kg/h.

A mixture of PET waste from bottles, fibers and thermoforming sheets was used as input material.

Operating time approx. 10 h

The melt temperature upstream of the melter reactor was recorded (FIG. 2, lower curve). The temperature of the polymer mass was measured with a temperature sensor immersed approx. 20 mm into the melt stream. The average input temperature was approx. 288° C. The fluctuation range of the melt temperature was approx. 35° C.

The intrinsic viscosity was measured inline after the melter reactor and amounted to an average of approx. 0.69 dl/g with a fluctuation range of approx. 0.07 dl/g (FIG. 2, upper curve).

### With Melt Cooler/Mixer:

Throughput of approx. 350 kg/h.

The same mixture of PET waste from bottles, fibers and thermoforming sheets was used as input material.

Operating time approx. 20 h

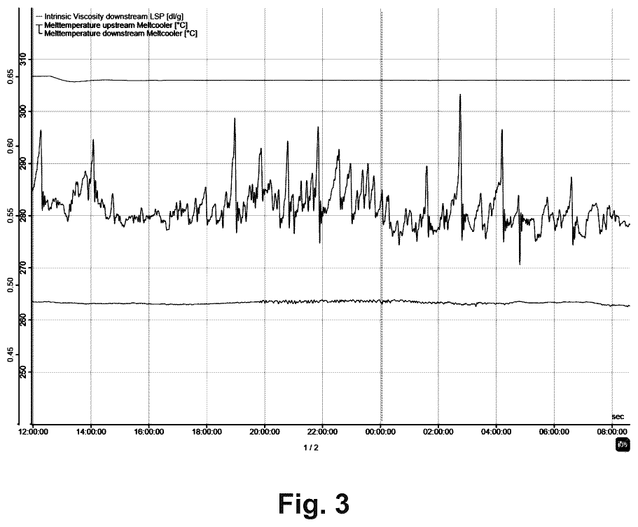

The melt temperature was recorded before the mixer/cooler (FIG. 3, middle curve) and after the mixer/cooler (FIG. 3, bottom curve). The temperature of the mass was measured with a temperature sensor immersed approx. 20 mm into the mass flow. The average input temperature was approx. 293° C. The melt was cooled to an average of 260° C.

The intrinsic viscosity was measured inline after the melter reactor and amounted to an average of approx. 0.65 dl/g. The fluctuation range was completely eliminated and was therefore better than the industry standard of +/−0.002 dl/g (FIG. 3, top curve).

This clearly shows the advantageous uniformity, predominant lowering and reduction in width of the melt temperature and intrinsic viscosity.

1. A process for processing polycondensates or materials containing polycondensates, in particular for recycling processing contaminated polycondensates, comprising the following processing steps:
a) Presenting of the polycondensates or materials to be processed, in particular in a container,
b) at least partial, in particular complete, melting of the polycondensates, in particular by extrusion in an extruder, and production of a polymer melt,
c) Mixing the polymer melt,
d) Tempering, in particular cooling, of the polymer melt,
e) Treatment of the mixed and tempered, in particular cooled, polymer melt in a melter reactor, in particular for polycondensation or post-condensation, for increasing the intrinsic viscosity and/or for purifying the polymer melt.

2. The process according to claim 1, wherein the processing steps are carried out in the specified sequence.

3. The process according to claim 1, wherein steps c) and d) are carried out simultaneously or in a common process step or in that the polymer melt is mixed and tempered, in particular cooled, at the same time.

4. The process according to claim 1, wherein filtration of the polymer melt is carried out before steps c) and d) in order to remove unmelted components and/or impurities.

5. The process according to claim 1, wherein degassing of the filtered polymer melt takes place before step c) and d).

6. The process according to claim 1, wherein the polymer melt is mixed distributivity.

7. The process according to claim 1, wherein the polymer melt is mixed and/or tempered, in particular cooled, in such a way that the temperature distribution in the polymer melt is <+/−10° C., in particular <+/−5° C., preferably <+/−1° C.

8. The process according to claim 1, wherein the polymer melt is tempered, in particular cooled, in such a way that the temperature of the polymer melt immediately before or on entry into the melter reactor is 5-25% lower than the temperature of the polymer melt immediately before mixing and tempering, in particular cooling, or before steps c) and d).

9. The process according to claim 1, wherein the polymer melt is tempered, in particular cooled, in such a way that the temperature of the polymer melt immediately before or on entry into the melter reactor is 1-10% above the melting range of the polymer.

10. The process according to claim 1, wherein the polycondensates or materials are comminuted and/or heated before melting according to step b), in particular during step a), wherein it is preferably provided that the polycondensates or materials are heated and permanently mixed while maintaining their lumpiness and pourability, and optionally degassed, softened, dried, increased in viscosity and/or crystallized.

11. The process according to claim 1, wherein at least the processing steps c), d) and e), in particular all the processing steps provided, follow one another directly and immediately in terms of time and location, in each case without any further intervening processing step.

12. An apparatus for processing polycondensates or materials containing polycondensates, in particular for recycling processing contaminated polycondensates, comprising
a melting apparatus for melting the polycondensates to be processed and for producing a polymer melt,
a mixing apparatus downstream of the melting apparatus for mixing the polymer melt,
a tempering apparatus, in particular a cooling apparatus, downstream of the melting apparatus for tempering, in particular reducing, the temperature of the polymer melt,
a melter reactor connected thereto for treating the mixed and tempered, in particular cooled, polymer melt, in particular for polycondensation or post-condensation, for increasing the intrinsic viscosity and/or for purifying the polymer melt.

13. The apparatus according to claim 12, wherein the melter reactor is connected spatially directly and directly, without any further interposed functional unit, in the conveying direction to the mixing apparatus or the tempering apparatus, in particular cooling device, or is connected downstream of the mixing apparatus or the tempering apparatus, in particular cooling device, and is coupled in series in the process.

14. The apparatus according to claim 12, wherein the melting apparatus is an extruder, wherein the extruder comprises in particular a melt filter and/or a degassing zone.

15. The apparatus according to claim 12, wherein a cutter/compactor is connected upstream of the melting apparatus, in particular a cutter/compactor/extruder combination being provided, for comminuting and/or heating the polycondensates or materials, wherein the cutter/compactor is preferably configured to heat and permanently mix the polycondensates or materials presented while maintaining their lumpiness and flowability. materials, wherein the cutter/compactor is preferably set up and suitable for heating and permanently mixing the polycondensates or materials supplied while maintaining their lumpiness and pourability, and optionally for degassing, softening, drying, increasing their viscosity and/or crystallizing them.

16. The apparatus according to claim 12, wherein the mixing apparatus is a distributive mixer.

17. The apparatus according to claim 12, wherein the mixing apparatus is at the same time the tempering apparatus, in particular cooling apparatus, wherein in particular a melt-cooling mixer is provided.

18. The apparatus according to claim 12, wherein the melter reactor is an LSP reactor or an MSP reactor.

19. The apparatus according to claim 12, wherein the mixing apparatus and/or the tempering apparatus, in particular cooling apparatus, are controllable or controlled in such a way that the temperature distribution in the polymer melt is <+/−10° C., in particular <+/−5° C., preferably <+/−1° C.

20. The apparatus according to claim 12, wherein the mixing apparatus and/or the tempering apparatus, in particular cooling apparatus, are controllable or controlled in such a way that the temperature of the polymer melt immediately before or on entry into the melter reactor is 5-25% lower than the temperature of the polymer melt immediately before the mixing apparatus and the tempering apparatus, in particular cooling apparatus, or before the temperature control mixer, in particular cooling mixer.

21. The apparatus according to claim 12, wherein the mixing apparatus and/or the tempering apparatus, in particular cooling device, are controllable or controlled in such a way that the temperature of the polymer melt immediately before/upon entry into the melter reactor is 1-10% above the melting range of the polymer.
